(19) United States
(12) Patent Application Publication
(10) Pub. No.: US 2008/0202634 A1
(43) Pub. Date: Aug. 28, 2008

(54) Shaper Guard

(76) Inventor: Jack Yang, Fongyuan City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/116,261

(22) Filed: May 7, 2008

Related U.S. Application Data
(63) Continuation-in-part of application No. 11/415,178, filed on May 2, 2006, now abandoned.

(51) Int. Cl. B27G 21/00

(52) U.S. Cl. 144/251.2

(57) ABSTRACT

A shaper guard includes a fixture assembly having a sleeve adapted to be statically fixed on a shaper and a rotating member pivotally connected with the sleeve. A first guard panel has a connecting portion connected with the sleeve. A second guard panel has a connecting portion connected with the rotating member and is pivotable in concert with the rotating member with respect to the sleeve and the first guard panel. The second guard panel is biasable by the workpiece fabricated on the shaper and that has a simple structure.

### CROSS REFERENCE

The present application is a continuation-in-part application of U.S. patent application Ser. No. 11/415,178, filed on May 2, 2006, of which the entire disclosure is incorporated herein.

### BACKGROUND OF THE INVENTION

1. Field of the Invention

The present invention relates to a shaper guard, and in particular to a shaper guard that has a guard panel biased by the workpiece fabricated on the shaper and that has a simple structure.

2. Description of the Related Art

FIG. 1 shows a safeguard 1 for a known shaper 2. The safeguard 1 is formed of a panel. A bracket 3 is used for connecting the safeguard 1 is connected to the shaper 2. The bracket 3 includes a rod 4 extended therefrom for receiving a fixing block 5 that is used to hold the safeguard 1 in place. Further, the safeguard 1 is positioned at the front of the shaper 2 so as to provide protection for an operator standing at the front of the shaper 2.

While the safeguard 1 is adapted to preclude dust and chippings produced by workpiece fabricated on the shaper 2 from hurting the operator standing at the front of the shaper 2, it is applicant's understanding that this safeguard 1 is not adapted to provide an absolute protection to the operator. As a matter of fact, the safeguard 1 can not protect these byproducts of the workpiece from shooting upward from the shaper 2.

U.S. Pat. No. 5,117,880 to Kapton discloses a protective shield including a horizontal shied plate 310 and a vertical shield plate 320. However, the first and second shield plates 310 and 320 are configured with relatively complexities. The horizontal shield 310 is pivotable with a connector pin 314, and the vertical shield 320 is pivotable with a pin 318 extended from the horizontal shield 310. Further, the vertical shield 320 includes a slot 329 moveably receiving a projection 319 of the horizontal shield 310.

Also, U.S. Pat. No. 4,842,031 disclose a guard with a arcuate periphery. However, the guard is pivotally connected with two pins.

The present invention is, therefore, intended to obviate or at least alleviate the problems encountered in the prior art. Additionally, the present invention is intended to provide a safeguard that is adapted to be biased by the workpiece fabricated on the shaper more easily and effectively.

### SUMMARY OF THE INVENTION

A shaper guard in accordance with the present invention includes a fixture assembly having a sleeve adapted to be statically fixed on a shaper and a rotating member pivotally connected with the sleeve. A first guard panel has a connecting portion connected with the sleeve. A second guard panel has a connecting portion connected with the rotating member and is pivotable in concert with the rotating member with respect to the sleeve and the first guard panel. The second guard panel is biasable by the workpiece fabricated on the shaper.

The shaper guard also includes an engaging member and the rotating member includes a cutout comprising two sides cooperated to define an angle. The engaging member is selectively engagable with the sides when the rotating member is rotated.

It is an object of the present invention that the shaper guard has a simple structure.

It is another object of the present invention that the first and second guard panels are transparent, allowing the operator to easily inspect the condition of blade on the shaper.

It is yet another object of the present invention that the guard panels have angular range of motions corresponding to the angle defined by the sides.

It is still another object of the present invention that the rotating member is pivotable relative to the sleeve.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

### BRIEF DESCRIPTION OF THE DRAWINGS

For the present disclosure to be easily understood and readily practiced, the present disclosure will now be described in conjunction with the following figures, wherein;

FIG. 1 is a partial perspective view of a shaper with a conventional shaper guard.

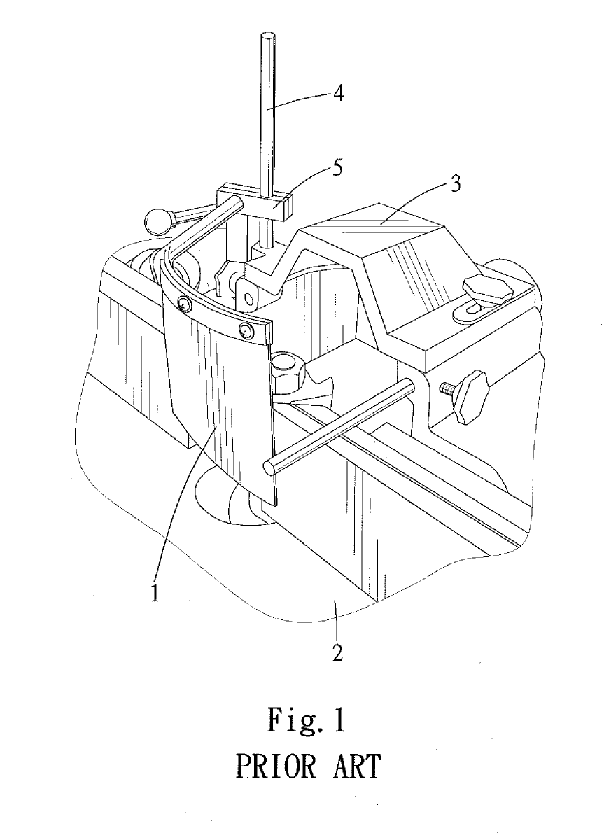

FIG. 2 is a perspective view of a shaper guard in accordance with the present invention.

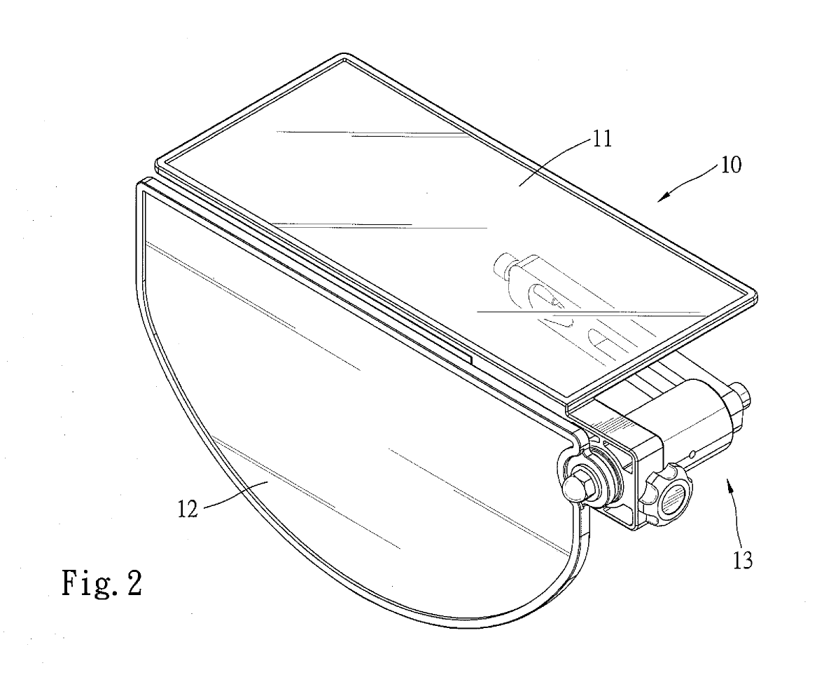

FIG. 3 is an exploded perspective view of the shaper guard of FIG. 2.

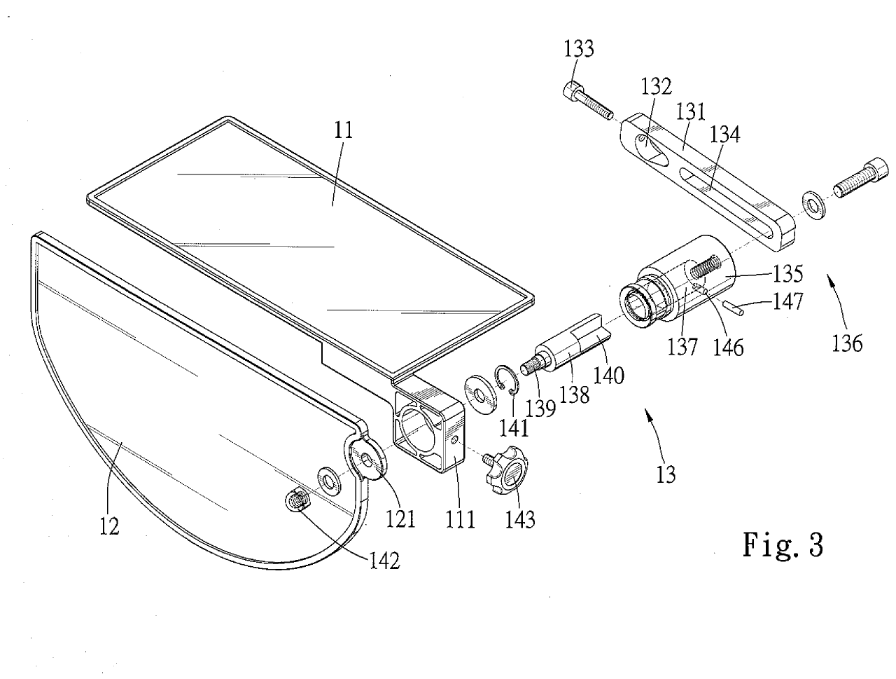

FIG. 4 is a perspective view showing the shaper guard of FIG. 2 installed on a work platform of a shaper.

FIG. 5 is a side view of FIG. 4.

FIG. 6 is a side view similar to FIG. 5, but illustrating the engagement of the shaper guard with the workpiece.

FIG. 7 is a sectional view taken along line 7-7 of FIG. 4.

FIG. 8 is a sectional view similar to FIG. 7, but showing a through hole with a profile which gradually becomes flared from a first end to a second end, adapted to be inserted by a shaft with larger diameter.

### DETAILED DESCRIPTION OF THE PREFERRED EMBODIMENT

Referring to the drawings, a shaper guard 10 in accordance with the present invention includes a first and a second guard panels 11 and 12 and a fixture assembly 13 connecting the panels 11 and 12 to a work platform 20 of a shaper as well as interconnecting the panels 11 and 12.

Preferably, the first and second guard panels 1 and 12 are transparent for allowing the operator to easily inspect the condition of blade on the shaper and are explosion-proof. Preferably, the second guard panel 12 has an arcuate periphery.

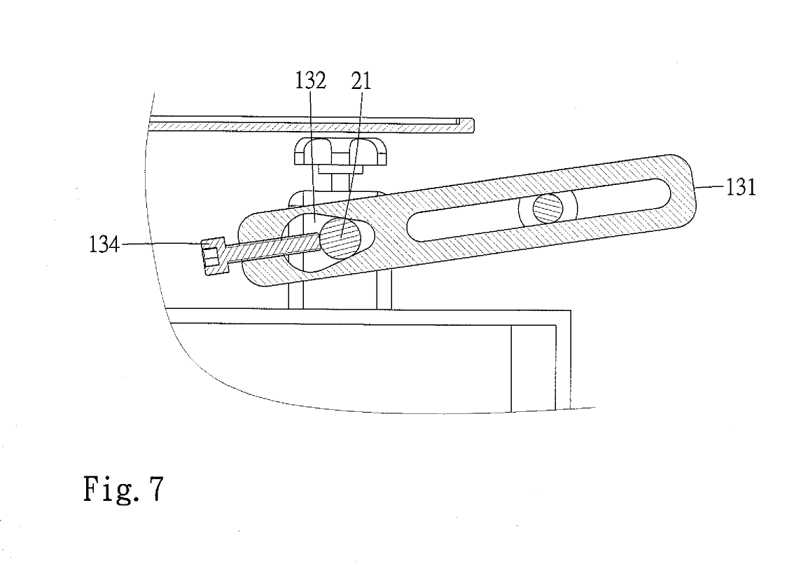

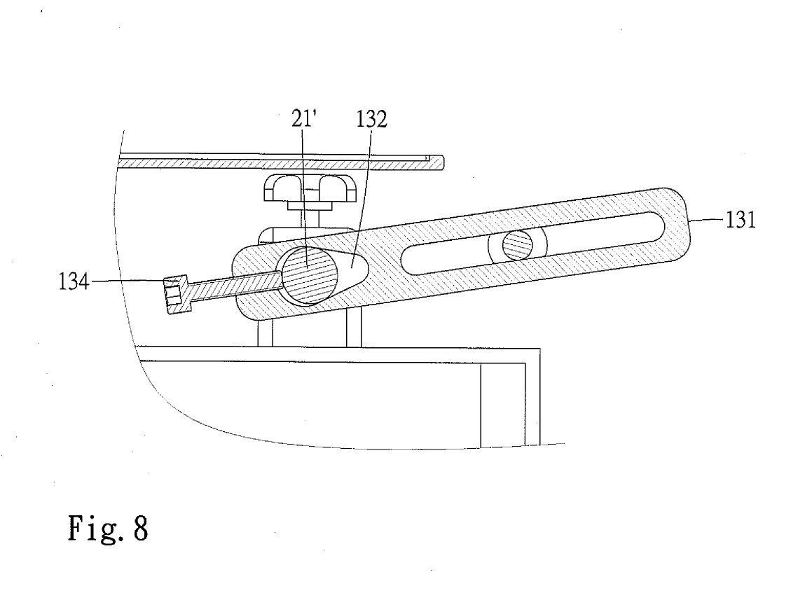

In this preferred embodiment, the fixture assembly 13 includes a fixture member 131 having a hole 132, and the work platform 20 has a fixing member 21 inserted through the hole 132 thereby connecting the fixture assembly 13 with the work platform 20. Further, the hole 132 has a profile which gradually becomes flared from a first end to a second end. With this configuration, the hole 132 is thus suitable for receiving at least two different dimensioned fixture members 21 and 21′, as illustrated in FIGS. 7 and 8. Further, a fastener 133 may be included to engage with the fixture member 131 for securely holding the fixture member 131 on the fixing member 21 in place.

The fixture assembly 13 further includes a sleeve 135 secured on the fixture member 131. Preferably, a connection means 136 or any other attaching means is utilized to secure the sleeve 135 on the fixture member 131. In this preferred embodiment, the connection means 136 includes a bolt 144 and an inner thread 145 defined in the sleeve 135. The bolt 136 is inserted through the fixture member 131, preferably a slot 134 defined in the fixture member 131, and then engaged in the inner thread 145 thereby holding the sleeve 135 on the fixture member 131 in place. Further, a gasket (not numbered) may be included for preventing the bolt 144 threaded on the fixture member 131 damaging the fixture member 131. Additionally, prior to fully tighten the sleeve 135 to the fixture member 131, the bolt 144 is adapted to change its position within the slot 134. Therefore, the sleeve 135 can be fixed at various positions with respect to the fixture member 131, giving the fixture assembly 13 more adaptability to the shaper.

Also, the sleeve 135 and the first panel 11 are connected. In this embodiment, the first guard panel 11 has a connecting portion 111 engaged on the sleeve 135 thereby connecting the sleeve 135 with the first panel 11.

The fixture assembly 13 further includes a rotating member 138 connected with the sleeve 135 and rotatable relative to the sleeve 135. In this preferred embodiment, the sleeve 135 includes a compartment 137 defined therein and the rotating member 138 is received in the compartment 137. Further, the compartment 137 is adapted to receive a seal 141 for confining the rotating member 138 within the sleeve 135.

The rotating member 138 includes a first end defining a threaded section 139 and a second end including a cutout 140 defining two sides cooperated to form an angle. The first end of the rotating member 138 is disposed outside the compartment 137 and is connected to the second guard panel 12. In this preferred embodiment, the second guard panel 12 has a connecting portion 121 that the threaded section 139 of the rotating member 138 is inserted through thereby connecting the second guard panel 12 with the rotating member 138. Further, an end cap 142 is engaged with the threaded section 139 of the rotating member 138 so as to prevent the second guard panel 12 as well as the first guard panel 11 from disengaging from the rotating member 138 and the sleeve 135 respectively. Additionally, a gasket (not numbered) may be included between the connecting portion 121.

The fixture assembly 13 further includes an engaging member 143 selectively engaged with two sides of the cutout 140 of the rotating member 138. As one side of the cutout 140 is engaged with the engaging member 143, further rotation of the rotating member 138 is inhibited. Likewise, as another side of the side of the cutout 140 is engaged with the engaging member 143, further rotation of the rotating member 138 is inhibited. Accordingly, the guard panels 11 and 12 have respective angular range of motions corresponding to the angle defined by the sides. In this preferred embodiment, the engaging member 143 is inserted through the connecting portion 111 of the first guard panel 11, the sleeve 135, and engaged with the cutout 140 disposed within the compartment 137 in the sleeve 135.

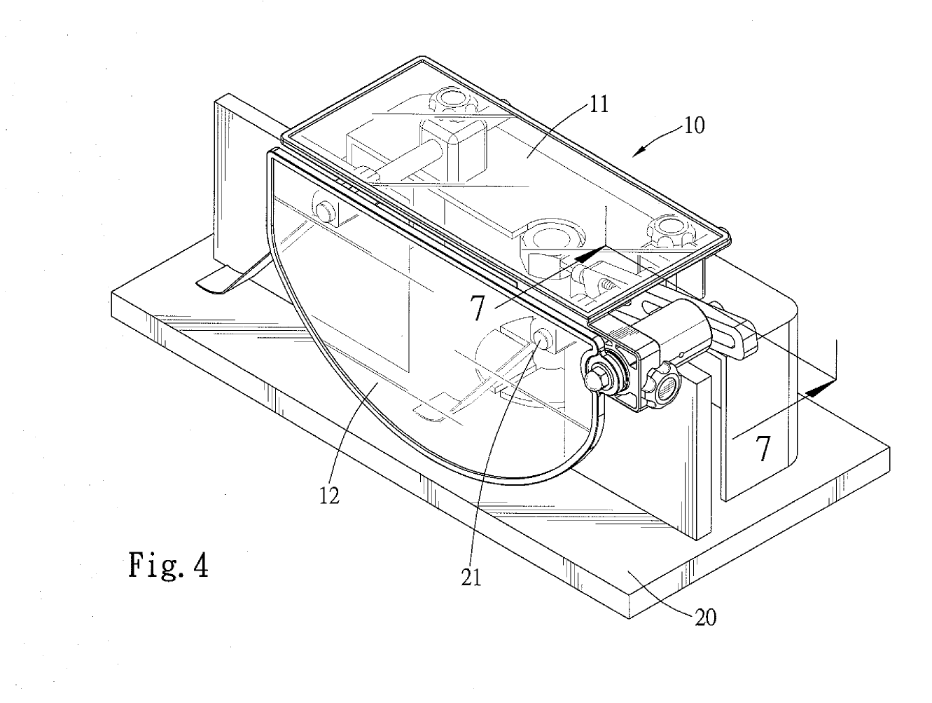

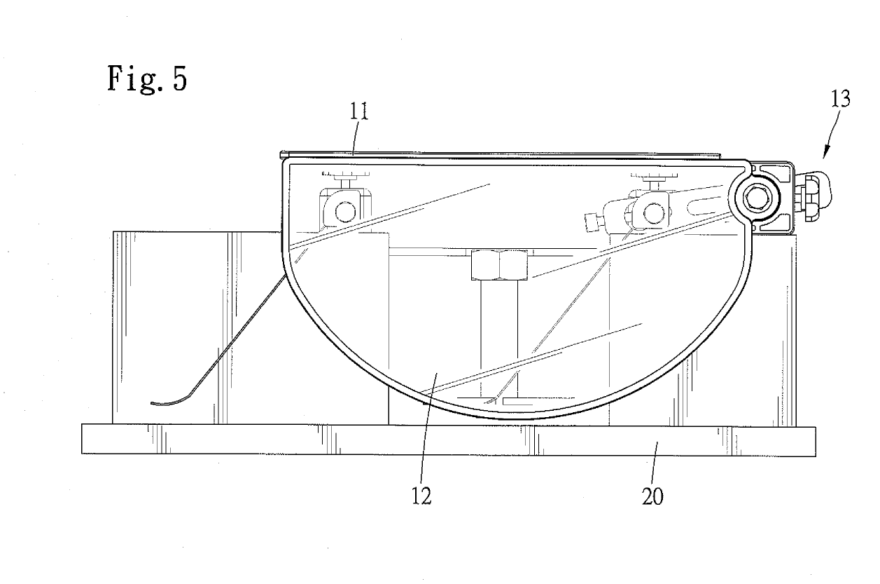

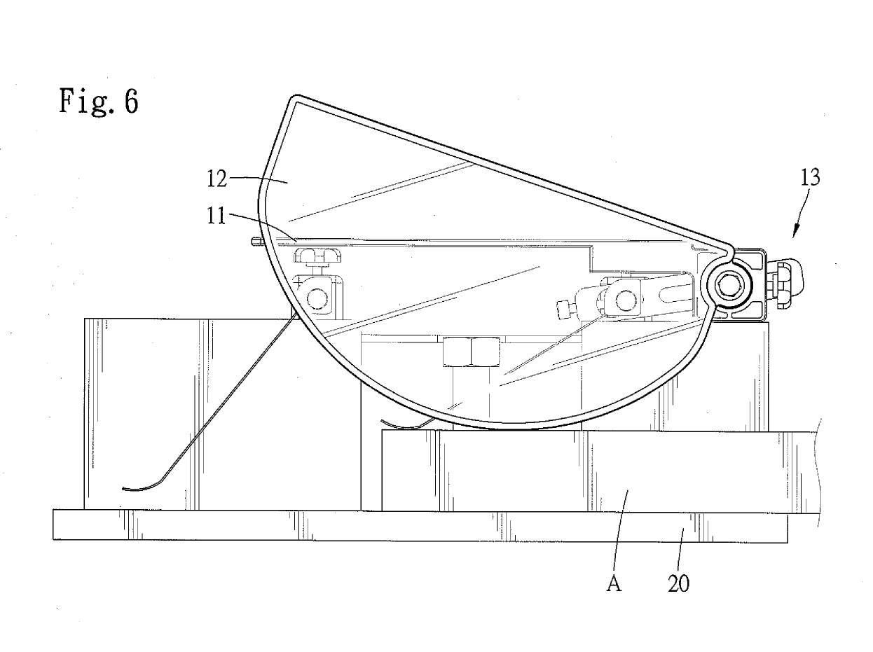

Referring to FIGS. 4 through 6, when a shaper is installed with the shaper guard 10 of the present invention, the first guard panel 11 is substantially parallel to the work platform 20 while the second guard panel 12 is substantially perpendicular to the work platform 20. As a workpiece A is gradually moved from the far right side to the far left side of the work platform 20, the second guard panel 12 is adapted to be elevated easily by the workpiece A due to its arcuate periphery and be pivoted in concert with the rotating member 138. Additionally, the second guard panel 12 is adapted to pivot back to the position as shown in FIG. 5 after the workpiece A is not engaged with the second guard panel 12.

While the specific embodiments have been illustrated and described, numerous modifications come to mind without significantly departing from the spirit of invention and the scope of invention is only limited by the scope of accompanying claims.

What is claimed is:

1. A shaper guard comprising:
a fixture assembly including a sleeve adapted to be statically fixed on a shaper and a rotating member pivotally connected with the sleeve;
a first guard panel having a connecting portion connected with the sleeve; and
a second guard panel, having a connecting portion connected with the rotating member and being pivotable in concert with the rotating member with respect to the sleeve and the first guard panel.

2. The shaper guard as claimed in claim 1, with the first and second guard panels being transparent.

3. The shaper guard as claimed in claim 1 with the first guard panel defining a surface and the second guard panel defining a surface perpendicular thereto.

4. The shaper guard as claimed in claim 1 wherein the sleeve comprises a compartment defined therein, and wherein the rotating member comprises a cutout disposed in the compartment.

5. The shaper guard as claimed in claim 4 wherein the sleeve comprises an aperture in communication with the compartment, and a pin received in the aperture, and wherein the cutout comprises two sides cooperated to define an angle, and with the pin selectively engagable with the sides when the rotating member is rotated.

6. The shaper guard as claimed in claim 5 further comprising a seal disposed in the compartment for confining the rotating member in the compartment.

7. The shaper guard as claimed in claim 5, with the first and second guard panels being transparent.

8. The shaper guard as claimed in claim 1 further comprising a fixture member for connecting the sleeve to a shaper, with the fixture member including a hole and a slot, and with the hole having a profile which gradually becomes flared from a first end to a second end.

9. The shaper guard as claimed in claim 8 further comprising a connection means including a bolt and a threaded section defined in the sleeve, and wherein the bolt is inserted through the slot and engaged in the threaded section whereby the sleeve is adapted to be secured on the fixture member.

10. The shaper guard as claimed in claim 9 wherein the sleeve comprises a compartment defined therein, and wherein the rotating member comprises a cutout disposed in the compartment.

11. The shaper guard as claimed in claim 10 further comprising an engaging member, and wherein the cutout comprises two sides cooperated to define an angle, and with the engaging member selectively engagable with the sides when the rotating member is rotated.

12. The shaper guard as claimed in claim 11 further comprising a seal disposed in the compartment for confining the rotating member 138 in the compartment.

13. The shaper guard as claimed in claim 11, with the first and second guard panels being transparent.

14. The shaper guard as claimed in claim 7, with the second panel having arcuate periphery.

15. The shaper guard as claimed in claim 13, with the second panel having arcuate periphery.
